(19) United States
(12) Patent Application Publication
(10) Pub. No.: US 2003/0009899 A1
(43) Pub. Date: Jan. 16, 2003

(54) Easy measurement tape

(76) Inventor: Jungeun Ha, Kyunggi (KR)

Correspondence Address: Eugene Oak, Ph.D., J.D., Patent Attorney, 610 S. Van Ness Ave., Los Angeles, CA, 90005, US

(21) Appl. No.: 10/125,867

(22) Filed: Apr. 22, 2002

(30) Foreign Application Priority Data
Jul. 12, 2001 (KR) 1-1-01-5196303-80

(51) Int. Cl. G01B 3/10

(52) U.S. Cl. 33/770

(57) ABSTRACT

A novel tape measure for a safer, more accurate and easier measuring, marking and cutting of raw materials for construction. The tape measure of this invention has a support and “T” shape tape lip. The support is installed within the housing below the tape. The support has “L” shape lip at the free end and has a “U” shape eyeliner for an accurate reading of the measure tape and for holding the tape in a normal arc shape. The support is sliding in and out of the housing through the same opening for the tape. The other side of the support, which remains in the housing, has scissors' blade shape. The whole shape of the support is of “Y” shape. The support slides in and out of the housing by moving the “L” lip from the bottom opening of the tape. The present tape measure is used not differently from the prior art tape measures when used to cut, measure or to draw a line. The support and the “T” shape tape lip allows a user a safer, more accurate, convenient and fast measuring, marking and cutting of raw materials for construction.

The present invention relates to a novel tape measure having a “Y” shape support with “L” shape lip and “U” shape eye liner at the free end and having a “T” shape tape lip for safer, more accurate, more convenient, and quick measuring, marking and cutting of raw materials for construction.

### BACKGROUND OF THE INVENTION

When a workman on a construction site cuts a rectangular panel of construction material of predetermined size from a full sheet, the work-man usually holds the utilities such as knife and pencil against the panel surface with one hand, while grasping the metal tape ruler surface, at a pre-measured position on the tape, with the other hand against the edge of the panel. Once positioned, the workman draws both hands in parallel motion across the surface of the panel. At this step, most of workmen have experience of cutting their finger by the coarse/sharp edge of the panel. In addition, it is very hard to reset the same length of measure once the tape is retracted.

It is the purpose of this invention to provide a novel tape measure with which the above-described inconvenience is avoidable and time is saved for a given job.

1. Field of Invention

The present invention relates to a novel tape measure having an inside housing installed sliding support with “L” lip and “U” shape eye liner at the free end and having a “T” shape tape lip. The tape measure of this invention enables a safer, more accurate, easier and time saving measuring, marking and cutting of raw materials for construction.

2. Description of the Prior Art

U.S. Pat. No. 5,966,820 to Cornacchio, et al. illustrates a sheetrock panel cutting device that is attachable to the free end of a conventional metal tape ruler. A utility knife is inserted into a preformed slot in a base plate, which causes the blade of the knife to be aligned juxtaposed to the right angle clip of the tape ruler. This attachment cannot protect the user's finger (34 in FIG. 1) from being scratched by the rough surface of cut sheetrock (36 in FIG. 1) when the hand, holding the measure, slides along the surface of the sheetrock.

U.S. Pat. No. 5,515,617 to Canfield illustrates a measuring, marking, and cutting tool comprising a tape measuring device within a housing which contains a pencil/knife holding attachment affixed to the distal end of the meta tape. The pencil/knife holder 15 in FIG. 6 is attached to a clip 14. The clip 14 tape. The pencil/knife holder 15 in FIG. 6 is attached to a clip 14. The clip 14 is attached to the end of the tape 12 is shown as a metal “tee” structure. This “tee” structure is comprised of a flat face 90 and an attached perpendicular to a leg 91. The face 90 has an aligning knob 92.

The aligning knob makes it uncomfortable for a user to attach a knife/pencil directly to this clip, mark and cut the sheet.

U.S. Pat. No. 5,815,940 to Valentine, Sr. introduces a take-out meter for attachment to a conventional metal retractable tape measure permitting accurate measurements without the need for repetitive subtractions of fittings measurements. The “take-out meter” is comprised of three basic parts, a tape receiver body 10, a tape-retaining view plate 20, and a pivotal clamp meter clip 30. The “take-out meter” is withdrawably installed in the tape measure housing while the tape passes through the tape receiving body as shown in FIG. 5 and FIG. 6. The view plate enables correct reading of the grid. The pivotal clamp holds the tape tightly in a desired position and act as a protector for a user's hand. However, the “take-out meter” is a little bit bulky and causes increase in the manufacturing cost.

None of the prior arts provides a safer, easier and accurate method of measuring, marking and cutting tools as convenient and economical as a conventional metal tape measure.

### SUMMARY OF THE INVENTION

Therefore, it is the purpose of this invention to provide a novel tape measure for a safer, more accurate and easier measuring, marking and cutting of raw materials for construction. The tape measure of this invention has a support and “T” shape tape lip. The support is installed within the housing below the tape. The support has “L” shape lip at the free end and has a “U” shape eyeliner for an accurate reading of the measure tape and for holding the tape in a normal arc shape. The support is sliding in and out of the housing through the same opening for the tape. The other side of the support, which remains in the housing, has scissors' blade shape. The whole shape of the support is of “Y” shape. The support slides in and out of the housing by moving the “L” lip from the bottom opening of the tape. The present tape measure is used not differently from the prior art tape measures when used to cut, measure or to draw a line. The support and the “T” shape tape lip allows a user a safer, more accurate, convenient and fast measuring, marking and cutting of raw materials for construction.

### BRIEF DESCRIPTION OF FIGURES

FIG. 1 is a perspective view of the tape measure of this invention.

FIG. 1a is a bottom view of the measure tape of this invention.

FIG. 1b is a front view of the tape measure of this invention.

FIG. 2 is a perspective view of the “Y” shape support inside the tape housing.

FIG. 3a is a side view of the measure tape of this invention retracted.

FIG. 3b is a side view of the measure tape of this invention stretched for measure.

FIG. 4 is a perspective view of the tape measure of this invention compared with previous tape measures having “L” shape lip.

FIG. 5 is an overview of the eye liner of this invention compared with previous eyeliner for measure tape.

### DETAILED DESCRIPTION OF THE PREFERRED EMBODIMENTS

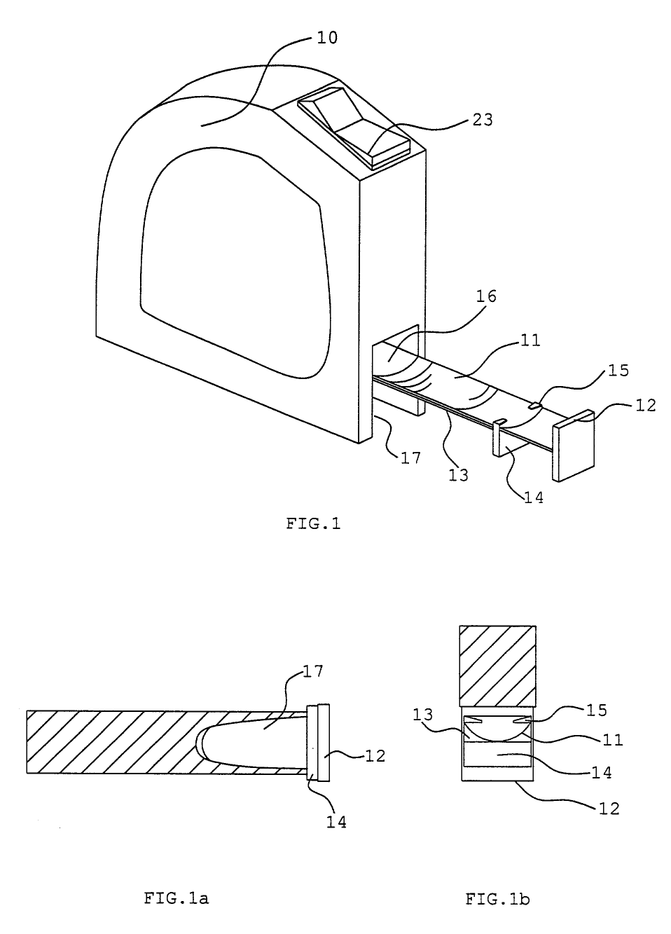

FIG. 1 is a perspective view of the tape measure of this invention. The tape housing (10) is similar to a conventional tape measure in shape and size. The tape (11) has “T” shape lip (12) at the free end. The tape (11) is supported by “Y” shape support (13), which has “L” shape lip (14) and “U” shape eyeliner (15) at the free end of the support (13). The “Y” shape support is sliding in and out of the tape housing (10) through the same opening (16) for the tape. FIG. 1a is a bottom view of the measure tape of this invention. A user can take out the “Y” shape support (13) and tape (11) from the tape housing (10) by put a finger into the opening (17) and drag the “L” shape lip (14) of the support (13) and “T” shape lip (12) of the tape (11). FIG. 1b is a front view of the tape measure of this invention. The “U” shape eyeliner (15) and the surface of the support (13) maintain the tape (11) to be shaped as an arc.

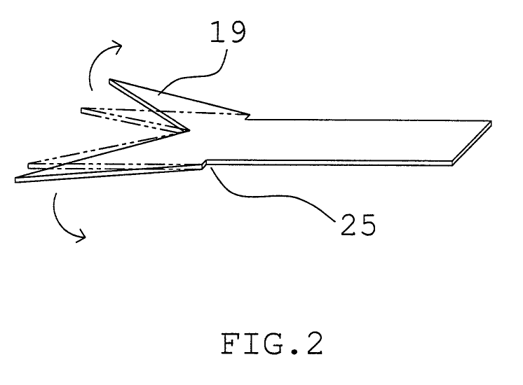

FIG. 2 is a perspective view of the “Y” shape support inside the tape housing. The “Y” shape structure (19) renders a frictional force to the support against the lower inner wall of the housing to prevent the support from pulling out of the housing accompanied with the tape. The projections (25) protect the “Y” shape support from drawing out of the tape housing (10).

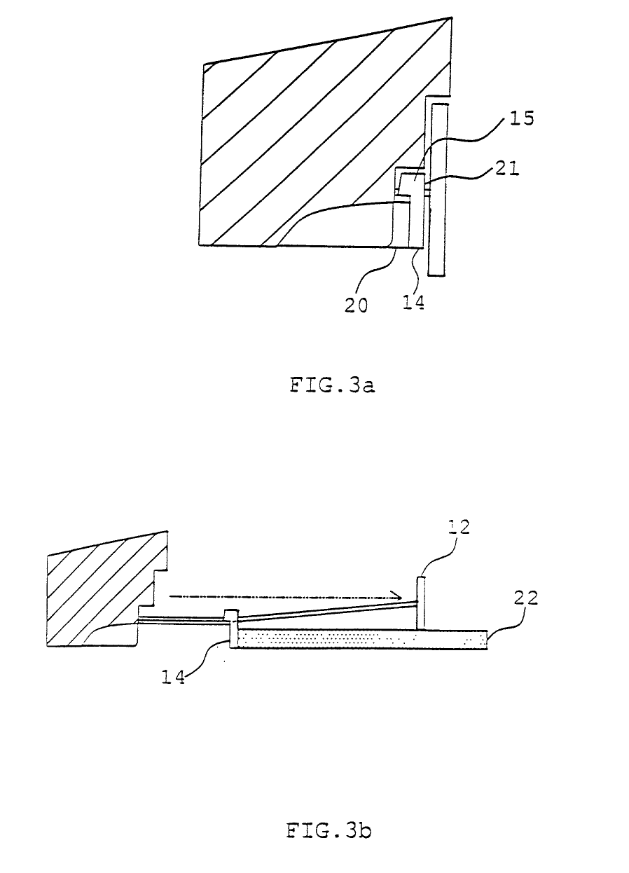

FIG. 3a is a side view of the measure tape of this invention retracted. The lower end of the “L” shape lip (14) lies on an imaginary straight surface (20) extended from the flat bottom of the tape housing (10). The front edge of the “U” shape eyeliner (15) and “L” shape lip (14) lies on a straight surface (21), which is perpendicular to the imaginary straight surface (20). FIG. 3b is a side view of the measure tape of this invention stretched. When a user try to draw a prefixed length of line on the sheet (22) of construction material, firstly, the user draw out the tape (11) from the tape housing (10), secondly, draw out the support (13) from the tape housing (10) and measure the desired length between the “U” eyeliner's front face (15) and “T” lip, thirdly, lock the tape (11) and the support (13) simultaneously by pressing the lock (23) shown in FIG. 1. After that, put the “L” shape lip (14) to the edge of the sheet of the construction material (22) and hold the upper part of the “T” shape lip (12) and press to the surface. By moving both of the “L” and “T” shape lip along the edge of the construction material sheet (22), a parallel line of prefixed distance from the edge is drawn. If the user try to cut the sheet of the construction material (22) with prefixed width, the user can cut the sheet directly by just attach and hold a knife to the outer surface of “T” shape lip and proceeds as previously described. It saves lots of time by eliminating the measuring, drawing step. The “L” lip (14) protects the user's finger, which is located behind the “L” lip, from hurt by the coarse/sharp surface of the edge of the construction material to be cut/draw a line. This enables a safer measuring, drawing and cutting.

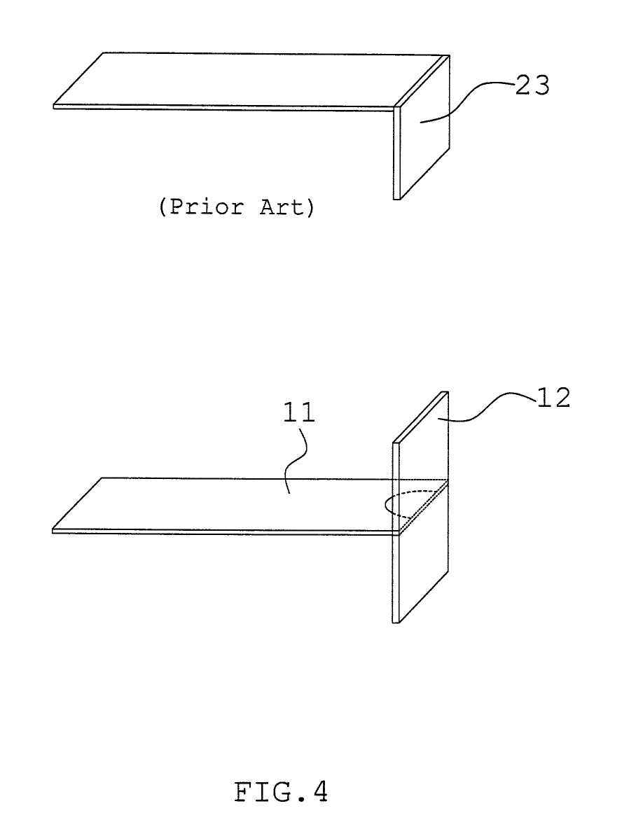

FIG. 4 is a perspective view of the tape measure of this invention compared with previous tape measure having “L” shape lip. The free end of the tape measures of prior arts have “L” shape lip (23). It is impossible to hold the tape end and draw line directly, and also is impossible to attach a knife/pencil and cut/draw a line directly. However, the “T” shape lip (12) of this invention provides a place to hold and attach a knife/pencil. It enables a user quick measuring, drawing and cutting at one step.

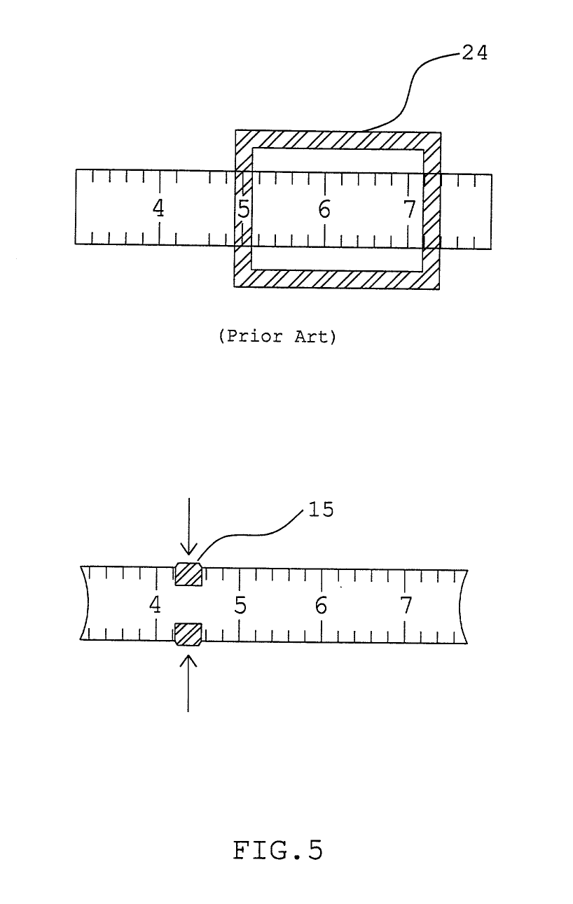

FIG. 5 is an overview of the eyeliner of this invention compared with previous eyeliner for measure tape. Most of the eyeliners of previous arts are such as shown (24). They are square type member with rectangular hole in the center. They are separately attached onto the tape to mark certain grid on the tape for every measurement. To dislocate the position of the eyeliner, the user has to disengage the screws on the eyeliner. They are usually too bulky to be installed in the measure housing. The eyeliner of this invention is a small blades stretched from the “Y” shape support (13). They are compact enough to be installed in the measure housing (10) of conventional tape measure's size and shape.

Above described features of this invention enables a safer, more accurate, convenient, and time saving measuring, marking and cutting of raw materials for construction. What is claimed is:

1. A novel tape measure having a “Y” shape support locked at the same time by the top lock, sliding in and out of the housing through the same opening for the tape by moving “L” shape lip of the support but not coming out of the housing accompanied with the tape and being protected from coming out because “Y” shape structure rendering friction force to the lower inner wall of the housing and the “L” shape lip at the free end is to protect user's finger and to provide a base surface which moves along the edge of construction materials to cut/draw lines and the “U” shape eyeliner is to give accurate reading and to prevent the tape from moving, and having a “T” shape tape lip, supplying handle for the user when using utility knife or pencil to cut/draw construction material sheets skipping previous inconvenient method.

2. The housing, in claim 1, has smooth “U” shape clearance for a fingertip to draw out the “L” lip at the front part of the lower face of the housing.
